(19) United States
(12) Patent Application Publication
(10) Pub. No.: US 2011/0087987 A1
(43) Pub. Date: Apr. 14, 2011

(54) APPLIANCE INTERFACE SYSTEM

(75) Inventor: Michael W. Brown, White House, TN (US)

(73) Assignee: Electrolux Home Products, Inc., Cleveland, OH (US)

(21) Appl. No.: 12/900,737

(22) Filed: Oct. 8, 2010

Related U.S. Application Data
(60) Provisional application No. 61/250,042, filed on Oct. 9, 2009.

(51) Int. Cl. G06F 3/048

(52) U.S. Cl. 715/771

(57) ABSTRACT

An appliance includes a user interface and a controller. The user interface comprises a plurality of selector buttons. Each selector button respectively comprises a display and a touch sensitive input area. The display can render an image thereupon for the selector button. Further, the display of the selector button can be separate from disparate displays of disparate selector buttons of the user interface. Moreover, the touch sensitive input area can be operable to receive an input selection that corresponds to the image rendered by the display of the selector button. The input selection received by the touch sensitive input area can cause the display of the selector button to change the image rendered thereupon and/or the disparate displays to change corresponding respective images rendered thereupon. The controller can respectively choose images rendered upon a plurality of displays and control operation of the appliance in response to the input selection.

### CROSS-REFERENCE TO RELATED APPLICATIONS

This application claims the benefit of U.S. Provisional Patent Application Ser. No. 61/250,042 entitled “APPLIANCE INTERFACE SYSTEM” which was filed Oct. 9, 2009. The entirety of the aforementioned application is herein incorporated by reference.

### FIELD OF THE INVENTION

The present invention relates generally to appliances, and more particularly, to an interactive informational interface display on ranges, stoves, and other appliances.

### BACKGROUND

Conventional appliances oftentimes include a user interface that has a centralized display that can render information to a user, where the user interface can also include a number of buttons. A user can employ the buttons to supply an input to the appliance, and the input can control operation of the appliance. However, the buttons sometimes are static in nature. For example, a first button can be labeled with the term “Next” and a second button can be labeled with the term “Select”. Following this example, the “Next” button is used to navigate through selectable fields rendered on the centralized display and the “Select” button is used to choose a particular field to perform an operation. Yet, employing statically defined buttons can cause the user interface to be difficult to employ by a user. According to another example, the buttons of the user interface sometimes are located on the centralized display. In accordance with this example, the buttons can be activated through resistive or capacitive touch cells embedded in the centralized display behind the images. However, the centralized display, which can be a large, single panel TFT or LCD screen, can be difficult to cool in an appliance, particular in a cooking appliance, due at least in part to the heat generated by the appliance. For instance, many TFT or LCD imaging displays have a +70 C temperature limit for dependable operation, while various cooking appliances will routinely exceed this limit and approach +105 C.

### SUMMARY

The following presents a simplified summary of the invention in order to provide a basic understanding of some example aspects of the invention. This summary is not an extensive overview of the invention. Moreover, this summary is not intended to identify critical elements of the invention nor delineate the scope of the invention. The sole purpose of the summary is to present some concepts of the invention in simplified form as a prelude to the more detailed description that is presented later.

In accordance with various aspects, an appliance that comprises a user interface and a controller is set forth herein. The user interface can include a plurality of selector buttons. Each selector button can respectively comprise a display that renders an image thereupon for the selector button, the display of the selector button being separate from disparate displays of disparate selector buttons in the plurality of selector buttons of the user interface of the appliance. Moreover, each selector button can respectively comprise a touch sensitive input area operable to receive an input selection that corresponds to the image rendered by the display of the selector button, wherein the input selection received by the touch sensitive input area causes one or more of the display to change the image rendered thereupon or at least one of the disparate displays to change corresponding respective images rendered thereupon. Further, the controller can respectively choose images rendered upon a plurality of displays of the plurality of selector buttons and control operation of the appliance in response to the input selection.

In accordance with other aspects, a method of operating an appliance is described herein. The method can include choosing a first set of images, wherein each image is representative of a corresponding function selectable for effectuation by the appliance. Further, the method can include rendering the first set of images upon a plurality of displays included in a user interface of the appliance, the plurality of displays being separate from each other. Moreover, the method can include receiving an input via one of a plurality of touch sensitive input areas respectively associated with the plurality of displays. Still yet, the method can include changing at least one image in the first set of images to yield a second set of images based upon the input. The method can also include controlling operation of the appliance based upon the input. The method can further include rendering the second set of images upon the plurality of displays.

It is to be understood that both the foregoing general description and the following detailed description present example and explanatory embodiments of the invention, and are intended to provide an overview or framework for understanding the nature and character of the invention as it is claimed. The accompanying drawings are included to provide a further understanding of the invention and are incorporated into and constitute a part of this specification. The drawings illustrate various example embodiments of the invention, and together with the description, serve to explain the principles and operations of the invention.

### BRIEF DESCRIPTION OF THE DRAWINGS

The foregoing and other aspects of the present invention will become apparent to those skilled in the art to which the present invention relates upon reading the following description with reference to the accompanying drawings, in which:

FIG. 1 is a front view of a typical range that incorporates an example user interface system in accordance with this invention;

FIG. 2 is a schematic view of example images displayable on an example image changeable button;

FIG. 3 is a schematic view of an array of example image changeable buttons;

FIG. 4 is a schematic view of another array of example image changeable buttons;

FIG. 5 is similar to FIG. 4, but shows the array of example image changeable buttons displaying different imagery;

FIG. 6 is similar to FIG. 4, but shows the array of example image changeable buttons displaying still different imagery;

FIG. 7A is an example schematic operation example of the image changeable buttons;

FIG. 7B is another example schematic operation example of the image changeable buttons;

FIG. 8A is a schematic view of an example touch sensitive interface portion for an image changeable button;

FIG. 8B is similar to FIG. 8A, but shows another example touch sensitive interface portion; and

FIG. 9 is a schematic circuit diagram for an example user interface system.

### DESCRIPTION OF EXAMPLE EMBODIMENTS

Example embodiments that incorporate one or more aspects of the present invention are described and illustrated in the drawings. These illustrated examples are not intended to be a limitation on the present invention. For example, one or more aspects of the present invention can be utilized in other embodiments and even other types of devices. Moreover, certain terminology is used herein for convenience only and is not to be taken as a limitation on the present invention. Still further, in the drawings, the same reference numerals are employed for designating the same elements.

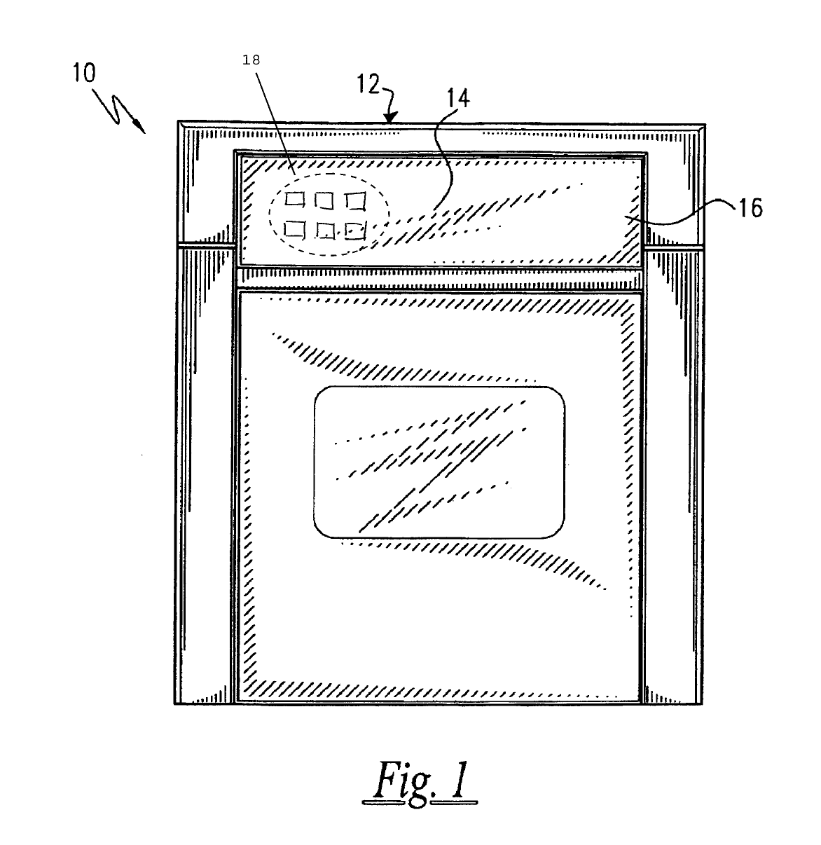

Turning to the various Figures, which are for purposes of illustrating examples of the invention only and not for purposes of limiting the same, FIG. 1 shows a front view of a typical range 10 that incorporates an appliance interface system in accordance with this invention. It is to be appreciated that the present invention may be utilized on any other sort of device. For example, the invention may be utilized on other types of appliances, such as large or small appliances. Examples of large appliances include washers, dryers, refrigerators, and freezers. Examples of small appliances include toasters, coffee makers, and microwave ovens. However, it is to be appreciated that the present invention may not be limited to use with an appliance or a particular type of appliance.

An example user interface 12 of the appliance interface system includes an interactive informational display area 14 and a covering surface 16, such as glass or plastic, etc. The example interactive informational display area 14 provides a plurality of selector buttons 18 used for providing user input to operate the range 10. As such, the user interface 12 communicates with the electronic control system (e.g., controller) of the range 10 to perform basic operations (e.g. cooking, baking, roasting, etc.) commonly known in the art and will not be further described herein. The example informational display area 14 can also display various additional types of information, such as oven temperature, minutes remaining until cooking is complete, current time via a clock, etc. For example, the information display area 14 can include a separate display (not shown), which is not linked to the plurality of selector buttons 18, that can display the above-noted additional types of information; however, it is to be appreciated that the claimed subject matter is not so limited. It is to be appreciated that the plurality of selector buttons 18 may have various constructions, configurations, and operation techniques. The plurality of selector buttons 18 can include touch sensitive input areas. For simplicity, the touch sensitive input areas are simply referred to as “buttons.” However, it is to be appreciated that touch alone may be sufficient to effect operation and that physical movement of the buttons may not occur.

The user interface 12 of the appliance interface system is an interactive system that generally utilizes one or more imaging displays capable of acting as selectors to guide a user through possible options that perform cooking functions. Thus, for the purpose of indicating to a user of the user interface 12 which action the apparatus is set to take at the activation of a particular selector button, a changeable visual indicator is provided on each of the particular selector buttons. The imaging displays can display static images, moving images (i.e., video), and/or may even include an audio component to “speak” to the user. The imaging displays can be arranged variously, such as in a pattern, array, etc. It is to be understood that the user interface 12, or even an additional interface system, can also include various other conventional buttons that do not include a display.

The user interface 12 can be coupled to a control system (e.g., controller) (not shown) that is an analog, digital, or even microprocessor-based control system. It is to be appreciated that the control system may be provided by any suitable components(s), operations(s), etc. such as a provision of information from a memory or an algorithm being performed, or even a digital to analog conversion circuit (D/A circuit). The control system can provide various digital or analog outputs that can directly or indirectly drive two or more displays for the various selector buttons (i.e., at least one display per button).

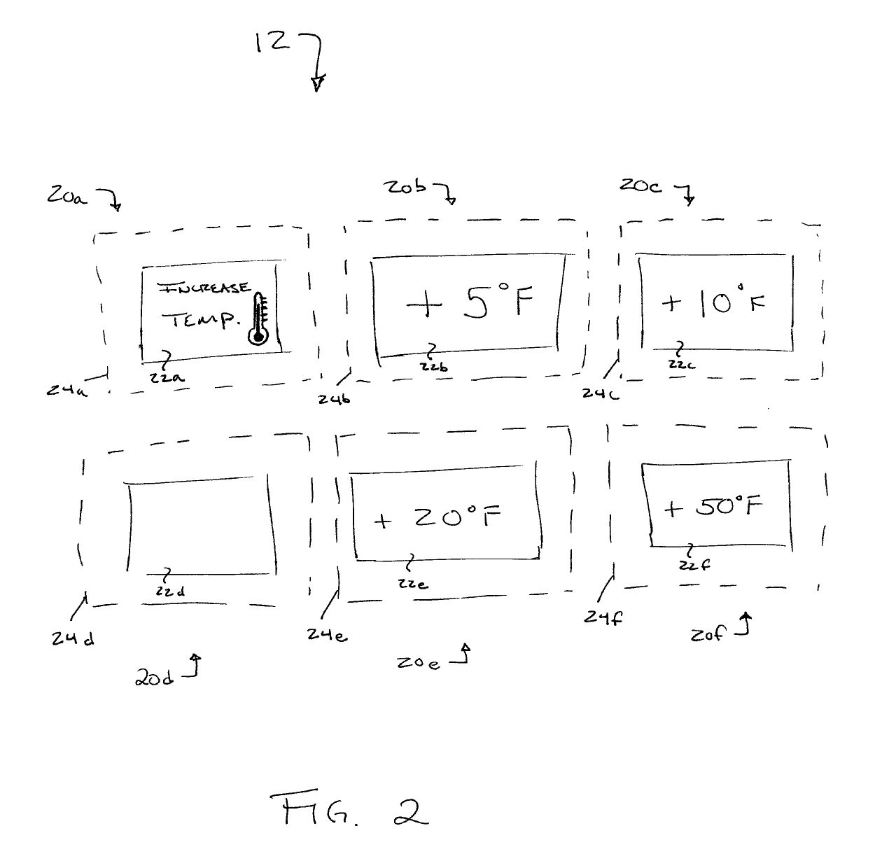

Examples of the user interface 12 of the appliance interface system are shown in FIGS. 2-5. Generally, such as shown in FIG. 2, the user interface 12 includes a plurality of selector buttons 20a-20f each including an image changeable display 22a-22f (e.g., display 22a-22f) and a touch sensitive interface portion 24a-24f (e.g., touch sensitive input area 24a-24f), as will be discussed more fully herein. In one example, the plurality of selector buttons 20a-20f can include six buttons that are arranged in an array. Still, it is to be understood that various numbers of selector button can be arranged variously about the user interface 12.

In an example interactive selection process, the concept is to provide the user with an interactive process through sight and sound rather than a set of conventional fixed sign type images. For example, a small group of displays arranged as a pattern are available showing text, static images, and/or a repeating video clip of possible activities. If a user wanted to make a known or previously used activity, the user can activate “my past successful meals” or some other desired wording for the activity. The idea is to reduce the number of possible selections made by a user to do simple, complex, or multi stage cooking.

The interactive selection process can be retained in memory of the appliance. For instance, images rendered upon each of the image changeable displays 22a-22f can be set forth by the interactive selection process. The interactive selection process can define a hierarchy that organizes images, and thus, functions corresponding to the images (e.g., to provide various levels of a menu, where different levels can be rendered). Moreover, in response to an input received by one of the touch sensitive interface portions 24a-24f, images rendered upon the image changeable displays 22a-22f (or a subset thereof) can be changed (e.g., to navigate through levels of a menu or sub-menu). Changing of the images rendered can be controlled as a function of the interactive selection process. Thus, a first collection of images can be displayed upon the image changeable displays 22a-22f during a first period of time, and upon receipt of an input obtained by one of the touch sensitive interface portions 24a-24f, a second collection of images can be displayed upon the image changeable displays 22a-22f during a second period of time, and so forth. Following this illustration, the first collection of images and the second collection of images, as well as the corresponding functions related thereto, can be specified by the interactive selection process.

According to an example, the interactive selection process retained in memory of the appliance can be pre-programmed for the appliance (e.g., by a manufacturer). By way of another example, the interactive selection process retained in memory of the appliance can be customizable by a user. Following this example, a relationship between a particular image that can be rendered upon a display and a particular selector button 20a-20f, as specified within the interactive selection process, can be defined based upon user input. Thus, a user can customize the interactive selection process to output a given image on a particular selector button 20a-20f (e.g., the interactive selection process can be customized to display “Bake Pie” on the selector button 20b). Additionally or alternatively, the collection of images with which the given image is grouped can be customized based on the user input (e.g., the user can customize the interactive selection process to place “Bake Pie” at a top level of a menu). By way of another example, a relationship between a particular image and a particular function can be defined, or customized, based upon user input. For instance, a library of images and a list of possible functions that can be performed by the appliance can be retained in memory of the appliance. User input can be obtained to link an image from the library to one or more of the possible functions from the list; however, it is to be appreciated that the claimed subject matter is not limited to the above-noted examples.

By way of another example, once activated, the display would “show the meal” through the text, static images, and/or video clips stored in the selection video memory on that display. When the desired activity was playing through, activating the selection area surrounding the display would start the process again. Intervention would be possible through another display, which when touched would query what the user would like to change in the existing process. Changes would page through the “changes” display until the user touches the display at the type of change desired. Example changes can include delay time to start, different temperatures, convection versus normal baking, etc.

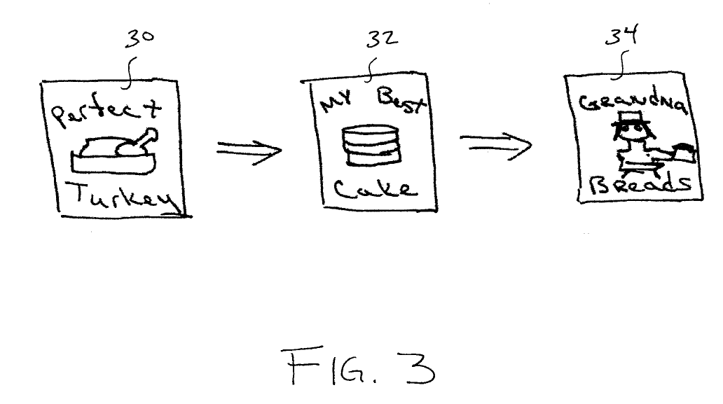

Various example images (or even video clips) are illustrated in FIG. 3. For example, the selector button 30 can display text, imagery, or video directed to an operational program for cooking a “Perfect Turkey.” Similarly, selector buttons 32 and 34 can display, respectively, text, imagery, or video directed to an operational program for cooking “My Best Cake” or “Grandma's Breads.” It is to be understood that the displays illustrated on buttons 30, 32, 34 can be displayed on separate buttons, or alternatively, can be displayed as alternatively displays on a single button. For example, the “Perfect Turkey” display 30 can be a portion of a meat cooking menu, while the “My Best Cake” and “Grandma's Breads” displays 32, 34 can be a portion of a baking menu.

For example, as shown in FIG. 2, a user can increase a desired temperature of the range using various interactive selection processes. In one example, where a higher temperature is desired, the user can press above or towards an upper portion of a selector button. In another example as shown in FIG. 2, a user can press a selector button 20a to select the interactive selection process for increasing the temperature, causing other selector buttons 20b, 20c, 20e, 20f to change their displays to provide selected temperature increases, such as in values of +5, +10, +20, and +50 degrees. The user activates the desired selection button by touching the button, and the control system thereby increases the temperature of the range 10 accordingly. Various other selector buttons 22d, such as unused buttons, can remain blank. Similarly, a user can decrease the temperature of the range 10 by following a similar interactive selection process, such as by touching below the button and/or selecting a “decrease temperature” button and then selecting an amount of temperature decrease, such as −5 or −10 degrees, etc.

In yet another example, the user interface 12 can be utilized to perform “chained” cooking activities. As used herein, “chained” cooking activities are various separate cooking activities that can be performed in successive order to accomplish a particular end result. Thus, the user interface 12 can automatically prompt the user with particular questions, and/or lead the user through a set of questions. The set of questions can be pre-programmed to set-up a collection of activities to be performed by the range 10. For example, when cooking a frozen food product, a group of “chained” cooking activities can include a thaw cycle (i.e., a preheat cycle) to bring the frozen food to a generally unfrozen state, a cook cycle to cook the food to a desired temperature or level of doneness, and/or a warming cycle to keep the cooked food at a desired, warm temperature until it is ready to be eaten. In other examples, if thaw, cook, cool down, and/or maintain activities were desired for a roast or pie, the item could be placed in the cooking cavity and a display providing chained cooking activities would be activated. Example choices can include frozen, fresh, cold, thawed, or room temperature, and a user could page through the various choices as a continuous process. If frozen was displayed and selected by a user, the display could then ask if the item was meat, poultry, fish, vegetable, pastry, etc. and as the type item is displayed activating the display would page to the next level of activities.

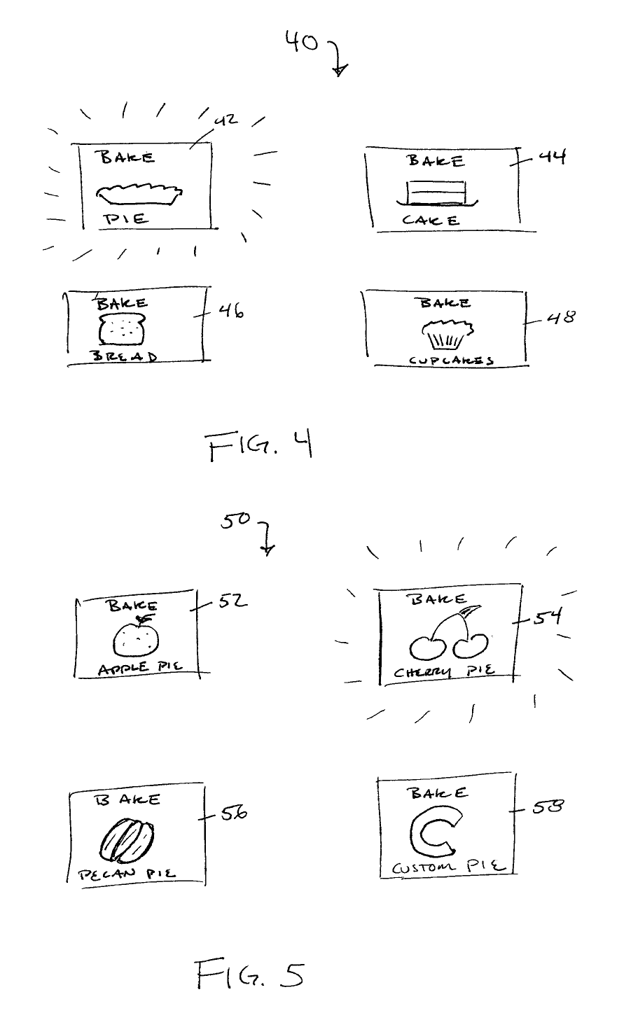

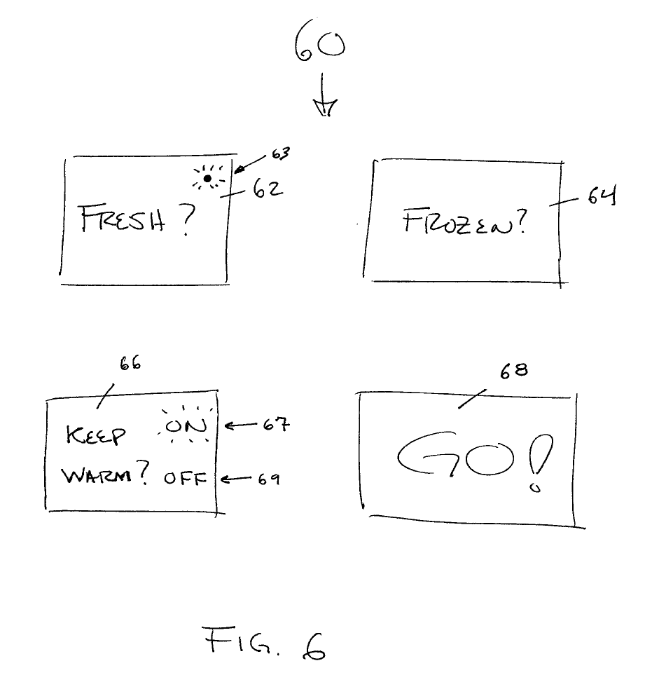

Optionally, the selections could be displayed on multiple displays simultaneously, such as in a ring pattern where any active display could be activated as a selection. By way of another example, as illustrated in FIGS. 4-6, a collection of “chained” cooking activities for a frozen pie could be identified and readied for cooking quickly with information input by the user and the pie thawed, cooked, cooled and maintained at a serving temperature as desired. As shown in FIG. 4, a first collection 40 of selector buttons can illustrate a sub-menu of baking choices, including “Bake Pie” 42, “Bake Cake” 44, “Bake Bread” 46, and “Bake Cupcakes” 48. A user desiring to bake a pie selects the “Bake Pie” 42 selector button by touching the button, which may increase in illumination, blink, flash, etc. and which may also generate audible indicators, video, etc. Turning now to FIG. 5, the user interface 12 drills-down to change the selector buttons to show a second collection 50 of selector buttons to illustrate a next sub-menu detailing types of pies to be baked. Example choices can include “Bake Apple Pie” 52, “Bake Cherry Pie” 54, “Bake Pecan Pie” 56, and “Bake Custom Pie” 58 (i.e., a customized pie baking program that can be entered by a user). As shown, “Bake Cherry Pie” 54 is chosen.

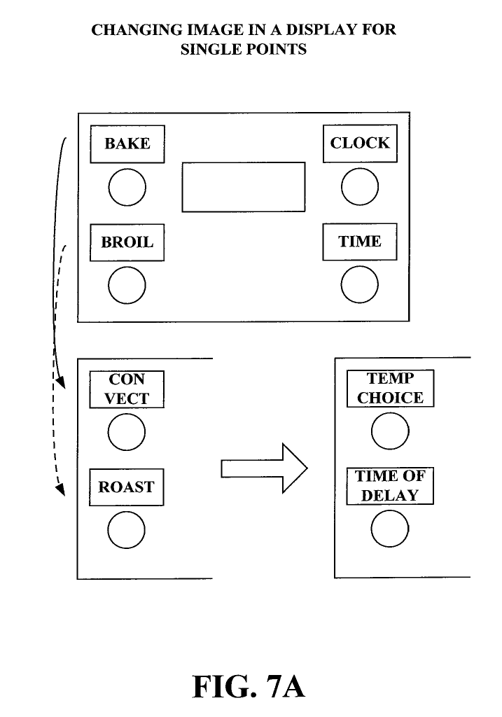

Turning now to FIG. 6, the user interface 12 changes the selector buttons to show a third collection 60 of selector buttons to illustrate a next sub-menu detailing options related to baking the cherry pie. Example option choices can include “Fresh” 62 versus “Frozen” 64 selector options to indicate whether the cherry pie to be baked is in a frozen state or fresh state (i.e., room temperature) to indicate whether the range 10 should perform a thaw cycle prior to baking. Where alternative choices are present on multiple selector buttons, an indicator 63 can show which of the alternative choices is presently selected (i.e., “Fresh” 62 is currently selected). Other options can include a “Keep Warm” selector 66 that can keep the baked pie warm after the baking cycle has completed. Where alternative choices are present on a single selector button, an indicator such as “On” 67 and “Off” 69 can show the presently selected option (i.e., the “Keep Warm” 66 option is presently selected as “On” 67). A user can toggle between the options by repetitively touching the associated button (i.e., by repetitively touching the “Keep Warm” button 66 to cycle between “On” 67 and “Off” 69). Finally, when all options have been selected, the user can initiate the collection of “chained” cooking activities by pressing the “Go” button 68. Thus, based upon the various selected options by the user via the user interface 12, the control system will operate the range 10 at a predetermined temperature for a predetermined time suitable for baking a fresh cherry pie, and will operate the range 10 at a second predetermined temperature for a second predetermined time for maintaining a “keep warm” cycle after the baking operation is complete.

It is to be understood that while illustrated in the various Figures with static images, any or all of the selector buttons can display video, animations, etc. For example, a “Help” selector button can display a video sequence to guide a user through the various steps of using the range 10 to perform various functions, such as baking a cherry pie or the like. According to another example, a “Back” selector button can be displayed; however, the claimed subject matter is not so limited.

In addition or alternatively, any of the displays of the various selector buttons could remain dark or otherwise maintain a static condition until activated by touching them, or even by passing a user's hand over them (i.e., as detected by a proximity sensor or the like). Once activated only the selected displays would begin to show images, video, etc. As a display was activated all others that were active could dim out and only the active display or possible alternate display selections would become active and only in turn.

In addition or alternatively, because many users have recipes that they refer to while cooking, the user interface 12 can include pre-programmed or custom recipes. For example, if the active display could talk to the user and recite the recipe or provide alternative methods to perform a process, cooking can become an interactive activity. Selection processes can be choreographed by a supplier (i.e., pre-programmed) or the user (i.e., custom). While multiple images might be displaying on various selector buttons at one time, generally only one selector button will have audible indicators (i.e., speaking) at one time. If an activity is lengthy or involves multiple options, multi-display short-cuts or the like could be used. A user could customize various operations and then save the customized operations as the recipe that would display the next time when the process was selected, and/or could be sorted as a “My Recipes” favorites selection.

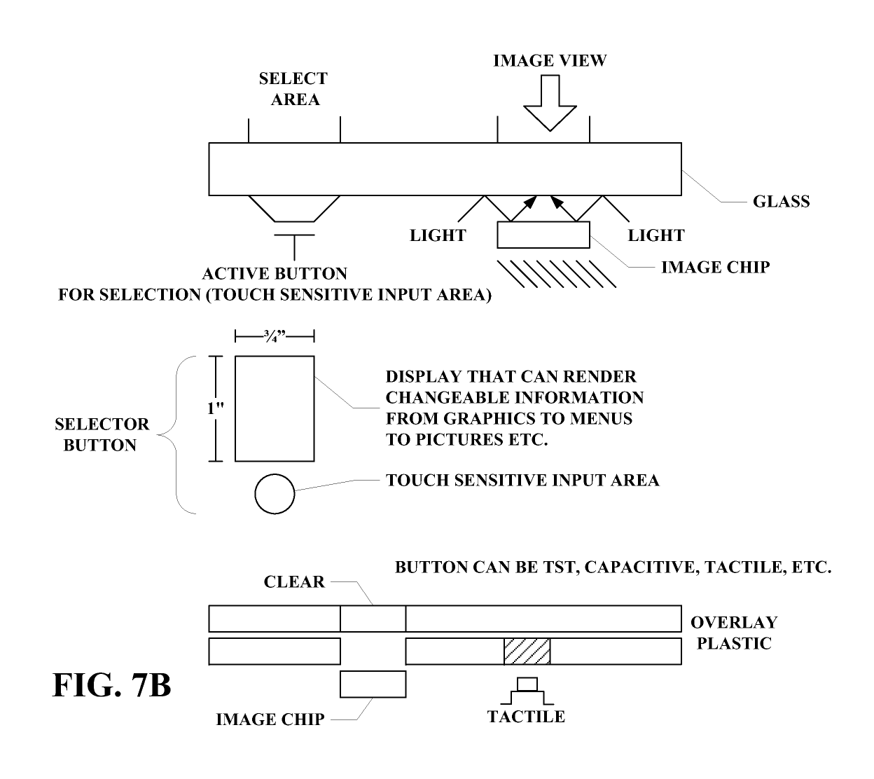

FIG. 7A and FIG. 7B provide an example schematic operation of the user interface 12 and include various example image changeable buttons and corresponding menu system as described herein. As shown in the example of FIG. 7A (and as specified by an interactive selection process), an input selection received by a touch sensitive input area of a selector button that displays “BAKE” or an input selection received by a touch sensitive input area of a selector button that displays “BROIL” can cause at least a portion of the selector buttons of the user interface to change images, namely to “CONVECT” and “ROAST”. Thus, the user interface prompts the user for a subsequent input selection. Further, upon obtaining the subsequent input selection via the touch sensitive input area of the selector button that now displays “CONVECT” or the touch sensitive input area of the selector that now displays “ROAST”, the images can again change as controlled by the interactive selection process to display “TEMP CHOICE” and “TIME of DELAY”. It is to be appreciated, however, that the claimed subject matter is not limited to the foregoing example.

FIG. 7B depicts various examples of a selector button that can include a display and a touch sensitive input area. For instance, the display can include an image chip. The display can render changeable information. According to another illustration, the touch sensitive input area can include an active button for selection.

Turning back to FIG. 2, the selector buttons 20a-20f can include various types of displays 22a-22f and various types of touch sensitive interface portions 24a-24f. In short, each selector button 20a-20f includes a dedicated imaging chip associated with a dedicated touch sensitive interface portion 24a-24f. The displays 22a-22f can by various LCD, TFT, CMOS, LCOS, dot matrix or any number of other types of single, double, triple, or quad multi-segment sized digit spaced indicators. Each display can be a relatively high density, relatively high resolution display device. Each image can be adjustable for brightness, contrast, content, color, etc. The images or streaming video for display thereon can be stored in digital memory and recalled and routed to the appropriate display depending upon which selector buttons are activated.

Various large, single panel TFT or LCD screens may be difficult to cool in cooking appliances because of the heat generated by the cooking appliance, such as a range 10. Many TFT or LCD imaging displays have a +70 C temperature limit for dependable operation, while various cooking appliances will routinely exceed this limit and approach +105 C. Thus, a large, single panel TFT or LCD screen can be replaced by a plurality of smaller areas in the interface panel areas that do not reach such high temperatures. In addition or alternately, small interface displays could be cooled using one or more coolers, such as Peltier coolers or the like.

Various example displays can be utilized. For example, relatively low cost 800×600 displays at 1.5 inch height and ¾ to 1 inch width can be utilized, though various other resolutions and/or sizes can also be used. Example displays can include various types from companies such as Display Tech (e.g., Models LDP-VGA, LDP-SVGA, LDM-0201-E or the like) and Planar (e.g., EL-series electroluminescent displays, LA, LB, LC-series AMCLD monitors, LX1200-series touch monitors, PLCD-series passive LCD products, or even SD-series stereoscopic LCD monitors). In another example, the displays can be obtained from Koppin Co., though displays from various other vendors are also contemplated.

Additionally, various types and/or combinations of touch sensitive interface portions 24a-24f can be utilized. It is to be understood that each touch sensitive interface portion 24a-24f can be associated with each individual display 22a-22f to form each individual selector button 20a-20f. Still, each touch sensitive interface portion 24a-24f can be associated with a plurality of the displays 22a-22f, and/or can even be a single touch sensitive interface portion having regions thereof assigned to one or more individual displays 22a-22f.

The touch-sensitive interface portions 24a-24f can include various types, including tactile, physically moveable buttons and/or switches, and generally non-physically movable buttons and/or switches (i.e., “touch” buttons). Various individual tactile buttons and/or switches can be used, each button being associated with physical movement (i.e., depressing a resilient button, etc.) and/or a physical make/break electrical switch connection. On the other hand, various examples of “touch” buttons can include resistive-touch systems, capacitive-touch systems, infrared-touch systems, surface acoustic wave touch systems, or the like.

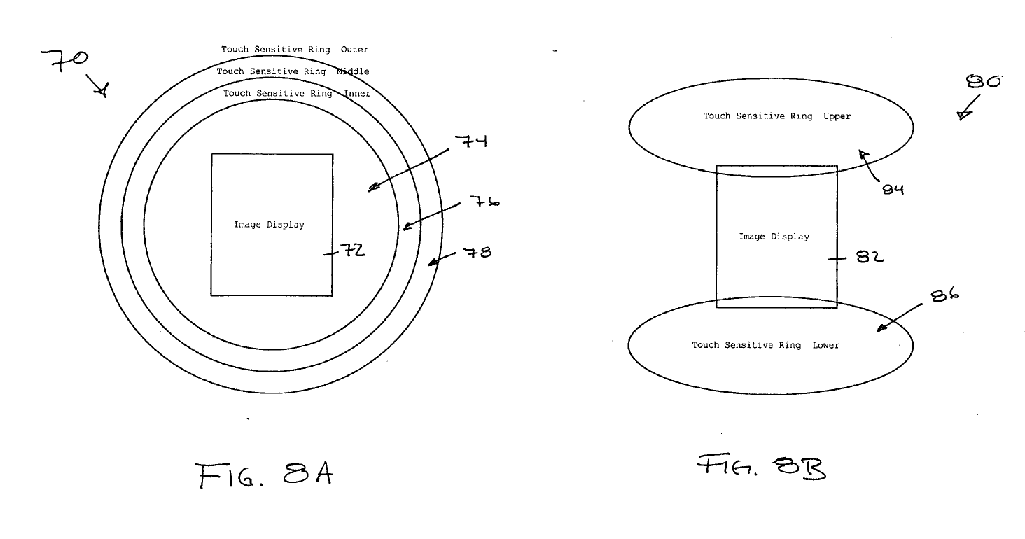

FIGS. 8A and 8B illustrate some example configurations of example “touch” buttons. For example, as shown in FIG. 8A, one example touch sensitive interface portion 70 can include an individual display 72 that can have various touch-sensitive regions 74, 76, 78 associated therewith. As shown, the touch-sensitive regions 74, 76, 78 can generally surround the display 72 and be arranged as generally concentric rings (i.e., inner ring 74, middle ring 76, outer ring 78) so provide a continuous array of “touch” buttons, though other configurations are contemplated. Thus, a user can touch any or all of the touch-sensitive regions 74, 76, 78 to obtain various actions. For example, a user can discretely touch each of the touch-sensitive regions 74, 76, 78 sequentially outward (i.e., ring 74 followed by ring 76 followed by ring 78) to indicate an increase in time or temperature, or a forwards cycling through menu options displayed on the display 72. Conversely, the regions 74, 76, 78 can be touched sequentially inward to indicate a decrease in time or temperature, or a backwards cycling through menu options displayed on the display 72. In other examples, a user can drag a finger sequentially across each of the regions 74, 76, 78 to indicate a desired selection change (increases, decreases, menu cycling, etc.). In addition or alternatively, each of the regions 74, 76, 78 can have sub-regions defined therein, such as top, bottom, left, and/or right (or even more) sub-regions. Thus, a user could discretely touch or drag a finger along a curved path, such as in a clockwise or counterclockwise direction around one of the regions 74, 76, 78 to indicate a desired selection change (increases, decreases, menu cycling, etc.).

Turning to FIG. 8B, another example touch sensitive interface portion 80 can include an individual display 82 that can have various touch-sensitive regions 84, 86 associated therewith. As shown, the touch-sensitive regions 84, 86 can be disposed generally about, and possibly overlapping, the display 82. However, the touch-sensitive regions 84, 86 can be separated a distance from each other to define separate and distinct touch regions (i.e., an upper ring or zone 84, and a lower ring or zone 86). Thus, a user can discretely touch any or all of the touch-sensitive regions 84, 86 to obtain various actions (increases, decreases, menu cycling, etc.). However, a user could touch both touch-sensitive regions 84, 86 at the same time to indicate yet another desired selection change, such as menu reset or various other actions. Moreover, though illustrated generally above and below the display 82, more or less regions can be arranged variously about the display 82 (i.e., left or right side rings or zone, angled zones, etc.). Though various examples have been described, it is to be understood that the “touch” buttons can also have various other configurations, geometries, zones, shapes, sizes, etc.

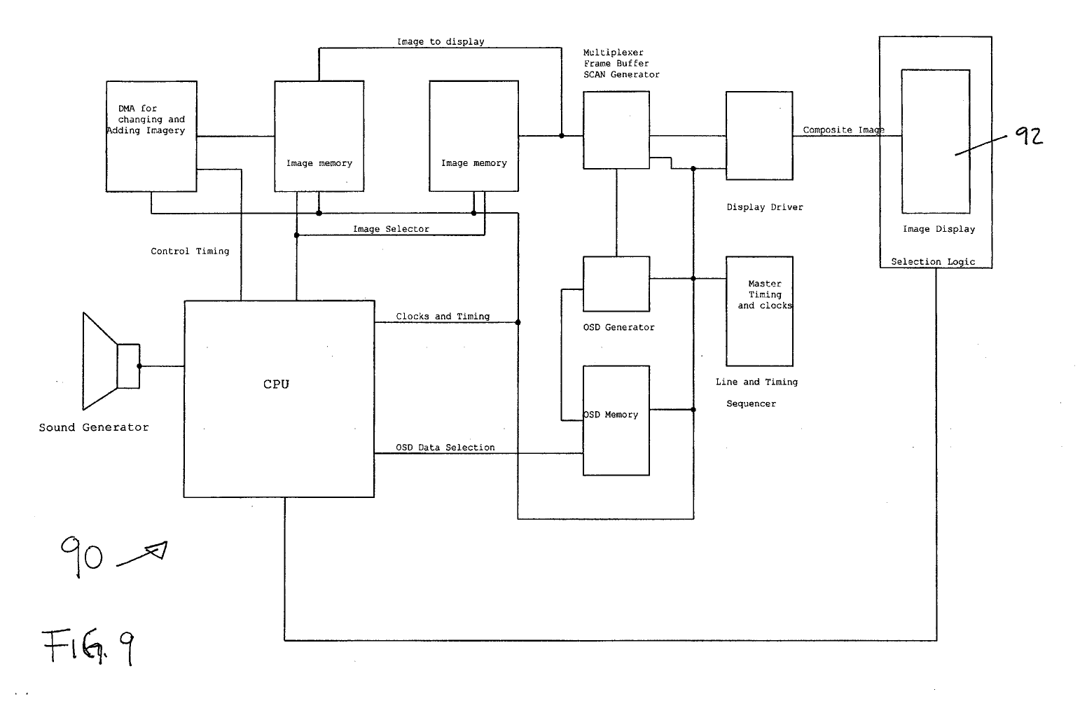

FIG. 9 is provides one example schematic electrical circuit 90 for implementing the example user interface system as described herein. The circuit 90 can include various example elements, logic, programming, etc. for displaying various images, movies, etc. on one or more displays 92 (only one display shown for clarity). For example, each display 92 can be driven by a separate and distinct circuit 90, or one circuit can drive multiple displays. The circuit 90 can also include various elements for providing various other types of output, such as sound output, other visual output, etc. In addition or alternatively, the circuit 90 can include various elements, logic, programming, etc. for controlling input received from one or more various interface buttons (not shown) or the like associated with the display 92, although the input functionality may also be controlled by another circuit.

The invention has been described with reference to the example embodiments described above. Modifications and alterations will occur to others upon a reading and understanding of this specification.

What is claimed is:

1. An appliance, comprising:
a user interface comprising a plurality of selector buttons, wherein each selector button respectively comprises:
a display that renders an image thereupon for the selector button, the display of the selector button being separate from disparate displays of disparate selector buttons in the plurality of selector buttons of the user interface of the appliance;
a touch sensitive input area operable to receive an input selection that corresponds to the image rendered by the display of the selector button, wherein the input selection received by the touch sensitive input area causes one or more of the display to change the image rendered thereupon or at least one of the disparate displays to change corresponding respective images rendered thereupon; and
the appliance further comprising a controller that respectively chooses images rendered upon a plurality of displays of the plurality of selector buttons and controls operation of the appliance in response to the input selection.

2. The appliance of claim 1, wherein the image rendered upon the display of the selector button is at least one of text, a static image, or a moving image.

3. The appliance of claim 2, wherein the moving image is a streaming video.

4. The appliance of claim 1, wherein the controller retrieves the images rendered upon the plurality of displays of the plurality of selector buttons from memory.

5. The appliance of claim 1, wherein the image rendered upon the display of the selector button is representative of a corresponding function selectable for effectuation by the appliance via the touch sensitive input area of the selector button.

6. The appliance of claim 5, wherein the input selection received by the touch sensitive input area causes the appliance to perform the corresponding function.

7. The appliance of claim 5, wherein the input selection received by the touch sensitive input area causes the plurality of displays to render a modified collection of images pertaining to the corresponding function upon receipt of the input selection received by the touch sensitive input area to prompt for a subsequent input selection using a sub-menu via at least one of the plurality of touch sensitive input areas.

8. The appliance of claim 1, wherein the display of the selector button includes a dedicated imaging chip.

9. The appliance of claim 1, wherein the display is incorporated into the touch sensitive input area of the selector button.

10. The appliance of claim 9, wherein the touch sensitive input area of the selector button includes a plurality of touch sensitive regions.

11. The appliance of claim 1, wherein at least a portion of the display is unfenced by the touch sensitive input area of the selector button.

12. The appliance of claim 1, wherein an indicator within the image rendered upon the display of the selector button is changed in response to the input selection received by the touch sensitive input area.

13. The appliance of claim 1, wherein the controller chooses the images rendered upon the plurality of displays of the plurality of selector buttons as set forth by an interactive selection process retained in memory of the appliance.

14. The appliance of claim 13, wherein the interactive selection process retained in the memory of the appliance is pre-programmed for the appliance by a manufacturer.

15. The appliance of claim 13, wherein the interactive selection process retained in the memory of the appliance is customizable by a user.

16. The appliance of claim 15, wherein a relationship between a particular image and a particular selector button within the interactive selection process is defined based upon user input.

17. The appliance of claim 15, wherein a relationship between a particular image and a particular function selectable for effectuation by the appliance is defined based upon user input.

18. A method of operating an appliance, comprising:
choosing a first set of images, wherein each image is representative of a corresponding function selectable for effectuation by the appliance;
rendering the first set of images upon a plurality of displays included in a user interface of the appliance, the plurality of displays being separate from each other;
receiving an input via one of a plurality of touch sensitive input areas respectively associated with the plurality of displays;
changing at least one image in the first set of images to yield a second set of images based upon the input;
controlling operation of the appliance based upon the input; and
rendering the second set of images upon the plurality of displays.

19. The method of claim 18, further comprising choosing the first set of images and changing the at least one image in the first set of images based upon an interactive selection process.

20. The method of claim 19, wherein the interactive selection process is pre-programmed for the appliance by a manufacturer.

21. The method of claim 19, further comprising customizing the interactive selection process in response to user input.
